(19) United States
(12) Patent Application Publication
(10) Pub. No.: US 2022/0319148 A1
(43) Pub. Date: Oct. 6, 2022

(54) IMAGE PROCESSING APPARATUS AND METHOD FOR CONTROLLING THE SAME

(71) Applicant: CANON KABUSHIKI KAISHA, Tokyo (JP)

(72) Inventors: Yuta Kawamura, Kanagawa (JP); Keisuke Midorikawa, Tokyo (JP)

(21) Appl. No.: 17/711,902

(22) Filed: Apr. 1, 2022

(30) Foreign Application Priority Data
Apr. 6, 2021 (JP) 2021-065015

(51) Int. Cl. G06V 10/75; G06V 10/22

(52) U.S. Cl. CPC G06V 10/75; G06V 10/235; G06V 2201/07

(57) ABSTRACT

In a case where a plurality of detection results by a plurality of dictionaries exists for the same subject, a subject type may not be correctly selected. An image processing apparatus includes a subject detection unit configured to detect a plurality of types of subjects for an input image, a detection reliability calculation unit configured to calculate detection reliability for the detected subjects, a priority subject setting unit configured to set the type of a subject as a priority subject, and a main subject determination unit configured to determine a detection result as a main subject from among the detected subjects based on the set priority subject and the detection reliability. the main subject determination unit determines one subject type in the same region based on the set priority subject, the detection reliability, and the types of the detected subjects.

### BACKGROUND OF THE INVENTION

### Field of the Invention

The present invention relates to an image processing apparatus having a subject detection function, and a method for controlling the image processing apparatus.

### Description of the Related Art

To detect a plurality of types of subjects based on image data captured by an imaging apparatus such as a digital camera, a known technique detects a plurality of types of subjects based on a learned model that has completed the machine learning for each subject type. To perform image capturing with the focal point, brightness, and color adjusted to suitable conditions with reference to detected subjects, it is necessary to determine one main subject from among the plurality of obtained subjects. Japanese Patent Application Laid-Open No. 2017-5738 discusses a method for determining a main subject for a plurality of detected subjects based on the stable existence factor that indicates whether subject detection is stably performed over a plurality of frames.

### SUMMARY OF THE INVENTION

The present invention is directed to providing an image processing apparatus capable of suitably detecting a subject even when a plurality of detection results by a plurality of dictionaries exists for the same subject, and a method for controlling the image processing apparatus.

According to an aspect of the present invention, an image processing apparatus includes a subject detection unit configured to detect a plurality of types of subjects for an input image, a detection reliability calculation unit configured to calculate detection reliability for the detected subjects, a priority subject setting unit configured to set the type of a subject as a priority subject, and a main subject determination unit configured to determine a detection result as a main subject from among the detected subjects based on the set priority subject and the detection reliability. In a case where detection results of a plurality of types of subjects exist in the same region, the main subject determination unit determines one subject type in the same region based on the set priority subject, the detection reliability, and the types of the detected subjects.

Further features of the present invention will become apparent from the following description of exemplary embodiments with reference to the attached drawings.

### BRIEF DESCRIPTION OF THE DRAWINGS

FIGS. 1A and 1B illustrate outer appearances of an imaging apparatus including an image processing apparatus.

FIGS. 2A and 2B are block diagrams illustrating a configuration of an imaging system including the image processing apparatus.

FIG. 3 illustrates an example of a method for setting a target subject to be preferentially detected by a user.

FIG. 4 is a flowchart illustrating overall processing.

FIGS. 5A and 5B illustrate examples of sequences for switching between a plurality of types of dictionary data.

FIG. 6 is a flowchart illustrating determination processing for determining subject types in the same region.

FIGS. 7A to 7F illustrate an example of type determination processing for determining subject types in the same region.

FIG. 8 is a flowchart illustrating main subject determination processing.

FIGS. 9A to 9C illustrate an example of the main subject determination processing.

FIG. 10 illustrates an example of a sequence for switching between a plurality of types of dictionary data in arbitrary specification by the user.

### DESCRIPTION OF THE EMBODIMENTS

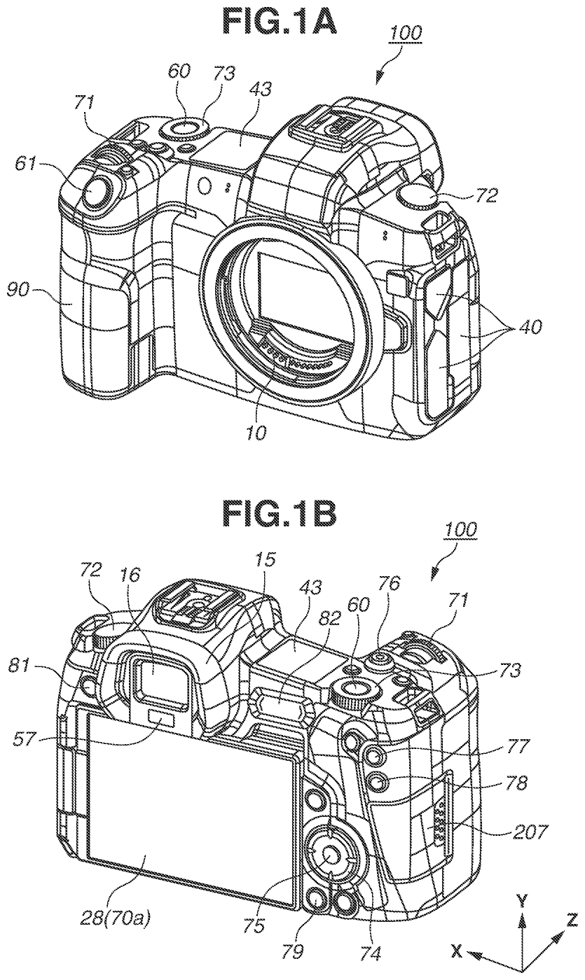

FIGS. 1A and 1B illustrate outer appearances of an imaging apparatus 100 including an image processing apparatus as an example of an apparatus to which the present invention is applicable. FIG. 1A is a perspective view illustrating the front face of the imaging apparatus 100, and FIG. 1B is a perspective view illustrating the rear face of the imaging apparatus 100.

Referring to FIGS. 1A and 1B, a display unit 28 disposed on the rear face of a camera displays an image and various kinds of information. A touch panel 70a can detect a touch operation on the display surface (operation surface) of the display unit 28. An extra-finder display unit 43, a display unit disposed on the top face of the camera, displays the shutter speed, diaphragm, and other various setting values of the camera. A shutter button 61 is an operation portion for issuing an imaging instruction. A mode selection switch 60 is an operation portion for switching between various modes. A terminal cover 40 is a cover for protecting connectors (not illustrated) of connection cables for connecting an external apparatus and the imaging apparatus 100.

A main electronic dial 71 is a rotary operation member included in an operation unit 70. Turning the main electronic dial 71 enables changing the setting values such as the shutter speed and the aperture. A power switch 72 is an operation member for turning power of the imaging apparatus 100 ON and OFF. A sub electronic dial 73, a rotary operation member included in the operation unit 70, enables moving a selection frame and feeding images. A cross key 74 included in the operation unit 70 is a cross key (four-way key) of which the upper, lower, right, and left portions can be pressed in. An operation corresponding to a pressed portion on the cross key 74 is enabled. A SET button 75, a push button included in the operation unit 70, is mainly used to determine a selection item.

A moving image button 76 is used to issue instructions for starting and stopping moving image capturing (recording). An automatic exposure (AE) lock button 77 included in the operation unit 70 is pressed in the shooting standby state to fix the exposure condition. An enlargement button 78 included in the operation unit 70 turns the enlargement mode ON or OFF in the live view display in the image capturing mode. After tuning ON the enlargement mode, the live view image can be enlarged and reduced by operating the main electronic dial 71. In the reproduction mode, the enlargement button 78 enlarges the playback image to increase the magnification. A playback button 79 included in the operation unit 70 switches between the image capturing mode and the reproduction mode. When the user presses the playback button 79 in the image capturing mode, the imaging apparatus 100 enters the reproduction mode, making it possible to display the latest image of images recorded in a recording medium 200, on the display unit 28. A menu button 81 included in the operation unit 70 is pressed to display on the display unit 28 a menu screen that enables the user to perform various settings. The user is able to intuitively perform various settings by using the menu screen displayed on the display unit 28, the cross key 74, and the SET button 75.

A touch bar 82 is a line-shaped touch operation member (line touch sensor) that accepts a touch operation. The touch bar 82 is disposed at a position where the user can operate with the thumb of the right hand that grips a grip portion 90. The touch bar 82 accepts a tap operation (touching the touch bar 82 and then detaching the finger without moving it within a predetermined time period) and a right/left slide operation (touching the touch bar 82 and then moving the touch position while in contact with the touch bar 82). The touch bar 82 is an operation member different from the touch panel 70a and is not provided with a display function.

A communication terminal 10 is used by the imaging apparatus 100 to communicate with the lens side that is attachable to and detachable from the apparatus. An eyepiece portion 16 of the eyepiece finder (look-in finder) enables the user to visually recognize the image displayed in an Electric View Finder (EVF) 29 inside the finder. The eye-contact detection unit 57 is an eye-contact detection sensor that detects whether the photographer's eye is in contact with the eyepiece portion 16. A cover 207 covers the slot that stores the recording medium 200. The grip portion 90 has a shape that is easy to grip with the right hand when the user holds the imaging apparatus 100.

The shutter button 61 and the main electronic dial 71 are disposed at positions where these operation members can be operated by the forefinger of the right hand while holding the digital camera by gripping the grip portion 90 with the little finger, the third finger, and the middle finger of the right hand. The sub electronic dial 73 and the touch bar 82 are disposed at positions where these operation members can be operated by the thumb of the right hand in the same state.

### (Configuration of Imaging Apparatus)

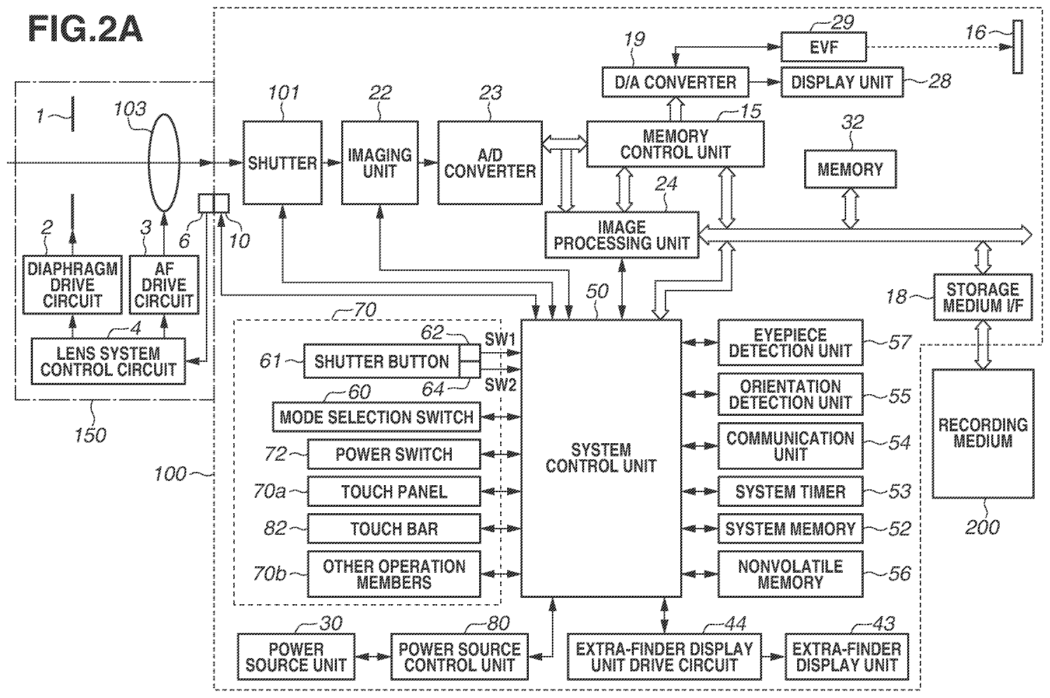

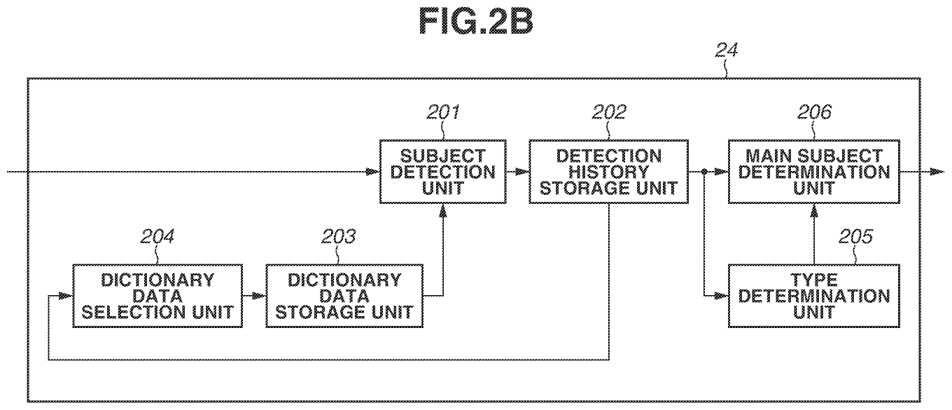

FIGS. 2A and 2B are block diagrams illustrating an example of a configuration of the imaging apparatus 100 according to the present exemplary embodiment. Referring to FIGS. 2A and 2B, a lens unit 150 mounts an interchangeable imaging lens. Although a lens 103 normally includes a plurality of lenses, FIG. 2A illustrates a single lens as the lens 103 for simplification. A communication terminal 6 is used by the lens unit 150 to communicate with the imaging apparatus 100. A communication terminal 10 is used by the imaging apparatus 100 to communicate with the lens unit 150. The lens unit 150 communicates with a system control unit 50 via the communication terminals 6 and 10. An internal lens system control circuit 4 controls a diaphragm 1 via a diaphragm drive circuit 2 and focuses on the subject by displacing the position of the lens 103 via an Automatic Focus (AF) drive circuit 3.

A shutter 101 is a focal plane shutter that enables arbitrarily controlling the exposure time of an imaging unit 22 under the control of the system control unit 50.

The imaging unit 22 is an image sensor including a Charge Coupled Device (CCD) or Complementary Metal Oxide Semiconductor (CMOS) sensor that converts an optical image into an electrical signal. The imaging unit 22 may be provided with an imaging plane phase-difference sensor that outputs defocus amount information to the system control unit 50. An analog-to-digital (A/D) converter 23 converts an analog signal into a digital signal. The A/D converter 23 converts the analog signal output from the imaging unit 22 into a digital signal.

An image processing unit 24 subjects the data from the A/D converter 23 or the data from a memory controller 15 to predetermined pixel interpolation, resizing processing such as reduction, and color conversion processing. The image processing unit 24 also subjects the captured image data to predetermined calculation processing. The system control unit 50 performs exposure control and distance measurement control based on the calculation result obtained by the image processing unit 24. This enables performing AF processing, Automatic Exposure (AE) processing, and Electronic Flash Preliminary Emission (EF) processing based on the Through-The-Lens (TTL) method. The image processing unit 24 also subjects the captured image data to predetermined calculation processing and performs TTL-based Automatic White Balance (AWB) processing based on the obtained calculation result.

The data output from the A/D converter 23 is written in the memory 32 via the image processing unit 24 and the memory controller 15, or directly written in the memory 32 via the memory controller 15. The memory 32 stores image data captured by the imaging unit 22 and then converted into digital data by the A/D converter 23, and image data to be displayed on the display unit 28 and the EVF 29. The memory 32 is provided with a sufficient storage capacity to store a predetermined number of still images, and moving images and sound for a predetermined time period.

The memory 32 also serves as an image display memory (video memory). A digital-to-analog (D/A) converter 19 converts image display data stored in the memory 32 into an analog signal and then supplies the signal to the display unit 28 and the EVF 29. The display image data stored in the memory 32 is displayed on the display unit 28 and the EVF 29 via the D/A converter 19. The display unit 28 and the EVF 29 display data on a liquid crystal display (LCD) or an organic electroluminescence (EL) display according to the analog signal from the D/A converter 19. The digital signal is once A/D-converted by the A/D converter 23, stored in the memory 32, and then converted into an analog signal by the D/A converter 19. Then, the analog signal is successively transferred to the display unit 28 or the EVF 29 to be displayed thereon to enable live view (LV) display. Hereinafter, an image displayed in the live view is referred to as a live view (LV) image.

The shutter speed, aperture, and other various setting values of the camera are displayed on the extra-finder display unit 43 via an extra-finder display unit drive circuit 44.

A nonvolatile memory 56 is an electrically erasable recordable memory such as an electrically erasable programmable read only memory (EEPROM). Constants and programs used for the operations of the system control unit 50 are stored in the nonvolatile memory 56. Programs stored in the nonvolatile memory 56 refer to programs for executing various flowcharts (described below) according to the present exemplary embodiment.

The system control unit 50 including at least one processor or circuit controls the entire imaging apparatus 100. Each piece of processing according to the present exemplary embodiment (described below) is implemented when the system control unit 50 executes the above-described programs recorded in the nonvolatile memory 56. A system memory 52 is, for example, a random access memory (RAM). Constants and variables used for the operations of the system control unit 50 and programs read from the nonvolatile memory 56 are loaded into the system memory 52. The system control unit 50 also controls the memory 32, the D/A converter 19, and the display unit 28 to perform display control.

A system timer 53 is a time measurement unit that measures time used for various kinds of control and time of a built-in clock.

The operation unit 70 is an operation member that inputs various operation instructions to the system control unit 50.

The mode selection switch 60, an operation member included in the operation unit 70, switches the operation mode of the system control unit 50 between the still image capturing mode, the moving image capturing mode, and the reproduction mode. The still image capturing mode includes the automatic image capturing mode, automatic scene determination mode, manual mode, aperture priority mode (Av mode), shutter speed priority mode (Tv mode), and program auto exposure (AE) mode (P mode). The still image capturing mode also includes various scene modes as imaging settings for each captured scene, and includes a custom mode. The mode selection switch 60 enables the user to directly select any one of these modes. Alternatively, the user may once select an image capturing mode list screen by using the mode selection switch 60, select any one of a plurality of displayed modes, and then change the mode by using other operation members. Likewise, the moving image capturing mode may also include a plurality of modes.

The first shutter switch 62 turns ON in the middle of the operation of the shutter button 61 provided on the imaging apparatus 100, what is called a half depression (imaging preparation instruction), to generate a first shutter switch signal SW 1. The first shutter switch signal SW 1 causes the system control unit 50 to start imaging preparation operations such as the auto focus (AF) processing, auto exposure (AE) processing, auto white balance (AWB) processing, and electronic flash preliminary emission (EF) processing.

The second shutter switch 64 turns ON upon completion of the operation of the shutter button 61, what is called a full depression (image capturing instruction), to generate a second shutter switch signal SW 2. In response to the second shutter switch signal SW 2, the system control unit 50 starts a series of operations in the shooting processing ranging from signal reading from the imaging unit 22 to captured image writing (as an image file) in the recording medium 200.

The operation unit 70 includes various operation members as input members that receive operations from the user.

The operation unit 70 includes at least the following operation members: the shutter button 61, the main electronic dial 71, the power switch 72, the sub electronic dial 73, the cross key 74, the SET button 75, the moving image button 76, an AF lock button 77, the enlargement button 78, the playback button 79, the menu button 81, and the touch bar 82. Other operation members 70b collectively indicate operation members not individually described in the block diagram.

A power source control unit 80 includes a battery detection circuit, a direct-current to direct-current (DC-DC) converter, and a switch circuit that selects a block to be supplied with power. The power source control unit 80 detects the presence or absence of a battery, the battery type, and the remaining battery level. The power source control unit 80 also controls the DC-DC converter based on the detection result and an instruction of the system control unit 50 to supply required voltages to the recording medium 200 and other components for required time periods. A power source unit 30 includes a primary battery (such as an alkaline battery or a lithium battery), a secondary battery (such as a NiCd battery, a NiMH battery, or a Li battery), and an alternating current (AC) adaptor.

A recording medium interface (I/F) 18 is an interface to the recording medium 200 such as a memory card or a hard disk. The recording medium 200 is, for example, a memory card for recording captured images, including a semiconductor memory or a magnetic disk.

A communication unit 54 establishes a wireless or wired connection to perform transmission and reception of video and audio signals. The communication unit 54 is also connectable with a wireless Local Area Network (LAN) and the Internet. The communication unit 54 can also communicate with an external apparatus through Bluetooth® and Bluetooth Low Energy. The communication unit 54 can transmit images (including the LV image) captured by the imaging unit 22 and images recorded in the recording medium 200, and receive images and other various kinds of information from an external apparatus.

An orientation detection unit 55 detects the orientation of the imaging apparatus 100 in the gravity direction. Based on the orientation detected by the orientation detection unit 55, the system control unit 50 can determine whether the image captured by the imaging unit 22 is an image captured with the imaging apparatus 100 horizontally held or an image captured with the imaging apparatus 100 vertically held. The system control unit 50 can add direction information corresponding to the orientation detected by the orientation detection unit 55 to the image file of the image captured by the imaging unit 22 or rotate the image before recording. An acceleration sensor or gyroscope sensor can be used as the orientation detection unit 55. Motions of the imaging apparatus 100 (pan, tilt, raising, and stand still) can also be detected by using an acceleration sensor or gyroscope sensor as the orientation detection unit 55.

### (Configuration of Image Processing Unit)

FIG. 2B illustrates a characteristic configuration of the image processing unit 24 according to the present exemplary embodiment. The image processing unit 24 includes a subject detection unit 201, a detection history storage unit 202, a dictionary data storage unit 203, a dictionary data selection unit 204, a type determination unit 205, and a main subject determination unit 206. Although, in the present exemplary embodiment, these units are described as a part of the image processing unit 24, these units may be provided as a part of the system control unit 50 or provided separately from the image processing unit 24 and the system control unit 50. For example, the image processing unit 24 may be provided on a smart phone or a tablet terminal.

The image processing unit 24 transmits image data generated based on data output from the A/D converter 23 to the subject detection unit 201 in the image processing unit 24.

According to the present exemplary embodiment, the subject detection unit 201 includes a convolutional neural network (CNN) that has completed the machine learning (deep learning) and detects a specific subject. Types of detectable subjects are based on dictionary data stored in the dictionary data storage unit 203. According to the present exemplary embodiment, the subject detection unit 201 includes a different CNN (different network parameters) depending on the types of detectable subjects. The subject detection unit 201 may be implemented by a graphics processing unit (GPU) or a circuit specialized for CNN-based estimation processing.

The CNN machine learning may be performed by using an arbitrary method. For example, a predetermined computer such as a server may perform the CNN machine learning, and the imaging apparatus 100 may acquire the learned CNN from the predetermined computer. According to the present exemplary embodiment, the predetermined computer inputs image data for learning, and performs supervised learning by using subject position information corresponding to the image data for learning as teaching data (annotation), enabling the CNN learning for the subject detection unit 201. This completes the generation of a learned CNN. The CNN learning may be performed by the imaging apparatus 100 or the above-described image processing apparatus.

As described above, the subject detection unit 201 includes a CNN (learned model) that has completed learning through the machine learning. The subject detection unit 201 inputs image data, estimates the position, size, and reliability of the subject, and outputs estimated information. The CNN may be, for example, a network having a layer structure (composed of convolution layers and pooling layers alternately stacked on top of each other), a fully connected layer, and an output layer, where the fully connected and the output layers are connected with the layer structure. In this case, for example, Backpropagation is applicable to the CNN learning. The CNN may be a Neocognitron CNN including a set of a feature detection layer (S layer) and a feature integration layer (C layer). In this case, for example, a learning technique named “Add-if Silent” is applicable to the CNN learning.

An arbitrary model other than a learned CNN may also be used for the subject detection unit 201. For example, a learned model generated through the machine learning, such as a support vector machine or a decision tree, may be applied to the subject detection unit 201. The subject detection unit 201 does not necessarily need to be a learned model generated through the machine learning. For example, an arbitrary subject detection method without using the machine learning may be applied to the subject detection unit 201.

The detection history storage unit 202 stores a subject detection history in image data detected by the subject detection unit 201. The system control unit 50 transmits the subject detection history to the dictionary data selection unit 204. According to the present exemplary embodiment, the detection history storage unit 202 stores the dictionary data used for subject detection, and positions, sizes, and reliabilities of detected subjects, as the subject detection history. The detection history storage unit 202 may additionally store data such as identifiers of image data that includes the number of times of subject detection and detected subjects.

The dictionary data storage unit 203 stores the dictionary data for detecting specific subjects. The system control unit 50 reads the dictionary data selected by the dictionary data selection unit 204, from the dictionary data storage unit 203, and then transmits the data to the subject detection unit 201. In the dictionary data for detecting each subject, for example, features of each region of the specific subject are registered. To detect a plurality of types of subjects, dictionary data for each subject and for each subject region may also be used. The dictionary data storage unit 203 stores dictionary data for detecting a plurality of types of subjects, including dictionary data for detecting “Person”, dictionary data for detecting “Animal”, and dictionary data for detecting “Vehicle”. In addition to dictionary data for detecting “Animal”, the dictionary data storage unit 203 may also store dictionary data for detecting “Bird” having special shapes and being subjected to high demand for subject detection among animals. The dictionary data storage unit 203 may also store dictionary data for “Automobile”, “Motorcycle”, “Train”, “Airplane”, and so on as subdivision of dictionary data for detecting “Vehicle”.

Subject regions detected by a plurality of types of dictionary data stored in the dictionary data storage unit 203 can be used as focal point detection regions. For example, in a composition including an obstacle on the front side and a subject on the rear side, a target subject can be brought into focus by focusing on the inside of a detected region.

Although, in the present exemplary embodiment, the plurality of types of dictionary data used in subject detection by the subject detection unit 201 is generated through the machine learning, dictionary data generated on a rule basis may be used or used together. The dictionary data generated on a rule basis refers to, for example, data that stores images of a subject to be detected or feature quantities specific to the subject, predetermined by the designer. The subject can be detected by comparing the images or feature quantities of the dictionary data with the images or feature quantities of captured image data. The rule-based dictionary data is less complicated and hence has a smaller data size than the model set by the learned model through the machine learning. Therefore, subject detection using the rule-based dictionary data provides a processing speed higher (and a processing load lower) than that provided by subject detection using the learned model.

The dictionary data selection unit 204 selects the dictionary data to be used next, based on the subject detection history stored in the detection history storage unit 202, the predetermined order and rules, or instructions from the user, and then notifies the dictionary data storage unit 203 of the selected dictionary data.

According to the present exemplary embodiment, the dictionary data storage unit 203 individually stores dictionary data for each of a plurality of types of subjects and for each subject region. Subject detection is performed on the same image data a plurality of number of times while switching between a plurality of types of dictionary data. The dictionary data selection unit 204 determines a dictionary data switching sequence and then determines the dictionary data to be used according to the determined sequence. An example of a dictionary data switching sequence will be described below.

When a plurality of subjects is detected in the same region, the type determination unit 205 determines the types of subjects for the region. The type determination unit 205 determines one detection result based on a subject setting to be preferentially detected set by the user via the operation unit 70 out of a plurality of detection histories stored in the detection history storage unit 202. The determination method will be described below.

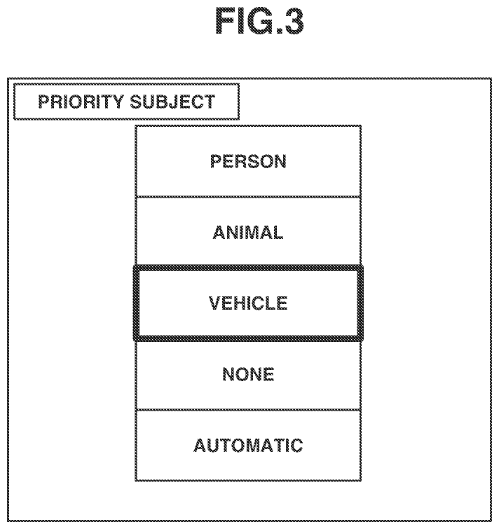

FIG. 3 illustrates an example where, in relation to a method for setting a subject to be preferentially detected, the user selects the type of the subject to be preferentially detected from the menu screen displayed on the display unit 28. FIG. 3 illustrates a setting screen for selecting a subject to be detected displayed on the display unit 28. The user selects a subject to be preferentially detected from specific detectable subjects (such as vehicles, animals, and persons) through an operation on the operation unit 70. FIG. 3 illustrates a state where “Vehicle” is selected. Referring to FIG. 3, “None” indicates a mode in which no subject is detected, and “Automatic” indicates a mode in which a subject is detected by giving priority to none of the specific detectable subjects.

The main subject determination unit 206 determines the main subject based on the plurality of detection histories stored in the detection history storage unit 202, the setting of the subject to be preferentially detected set by the user via the operation unit 70, and the subject determined by the type determination unit 205. A method for determining the main subject will be described below.

### (Processing Flow of Imaging Apparatus)

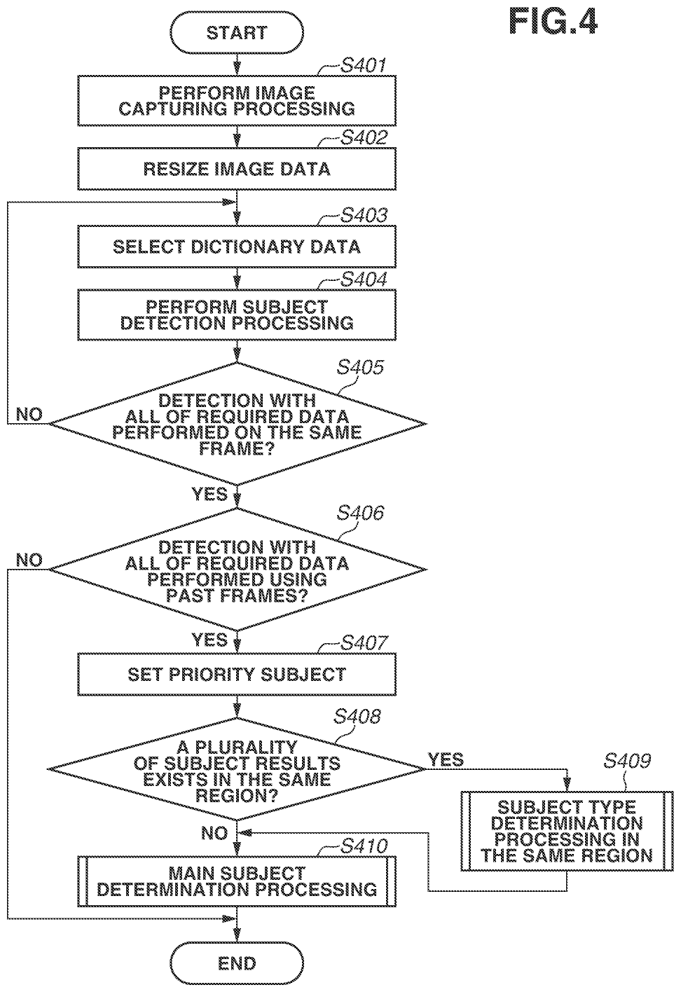

FIG. 4 is a flowchart illustrating the flow of characteristic processing of the present invention performed by the imaging apparatus 100 according to the present exemplary embodiment. Each step of this flowchart is executed by the system control unit 50 or by each unit following an instruction of the system control unit 50. When starting this flowchart, power of the imaging apparatus 100 is turned ON and the apparatus is in the live view image capturing mode in which the apparatus is ready to issue an instruction for starting static image or moving image capturing (recording) through an operation via the operation unit 70.

It is assumed that a series of processes from step S401 to step S409 in FIG. 4 is performed when the imaging unit 22 of the imaging apparatus 100 performs image capturing for one frame (one piece of image data). However, the present invention is not limited thereto. A series of processes from step S401 to step S409 may be performed over a plurality of frames. More specifically, the result of subject detection in the first frame may be reflected in any of the second and subsequent frames.

In step S401, the system control unit 50 acquires image data captured by the imaging unit 22 and then output by the A/D converter 23.

In step S402, the image processing unit 24 resizes the image data to fit it into an easy-to-process image size (e.g., Quarter Video Graphics Array (QVGA)) and then transmits the resized image data to the image data generation unit 201.

In step S403, the dictionary data selection unit 204 selects the dictionary data generated through the machine learning to be used for subject detection and then transmits selection information for identifying the selected dictionary data to the dictionary data storage unit 203.

The dictionary data generated through the machine learning can be generated by extracting common features of a specific subject from a large amount of image data containing the specific subject. Examples of common features include the background and other regions outside the specific subject in addition to the size, position, and color of the subject. Therefore, if the subject to be detected exists in a more restrictive background, the detection performance (detection accuracy) can be improved with a smaller amount of learning. On the other hand, if learning is performed intending to detect a specific subject regardless of the background, the versatility to captured scenes increases but the detection accuracy becomes hard to increase. The detection performance tends to increase with increasing amount and variety of image data to be used for dictionary data generation. On the other hand, even if the number and the variety of image data pieces required for dictionary data generation are reduced, the detection performance can be improved by restricting the size and position of the detection region for the subject to be detected to predetermined values in the image data used for subject detection. If a subject partly protrudes out of the image data, a part of features of the subject is lost, degrading the detection performance.

Generally, a larger subject region includes a larger number of features. In the detection using dictionary data that has completed the machine learning, an object having features similar to those of the specific subject to be detected with the dictionary data may be possibly mis-detected as the specific subject. A region defined as a local region is a small region in comparison with the entire region. The feature quantity included in a region decreases with decreasing area of the region, and the number of objects having similar features increases with decreasing feature quantity, resulting in an increase in mis-detection.

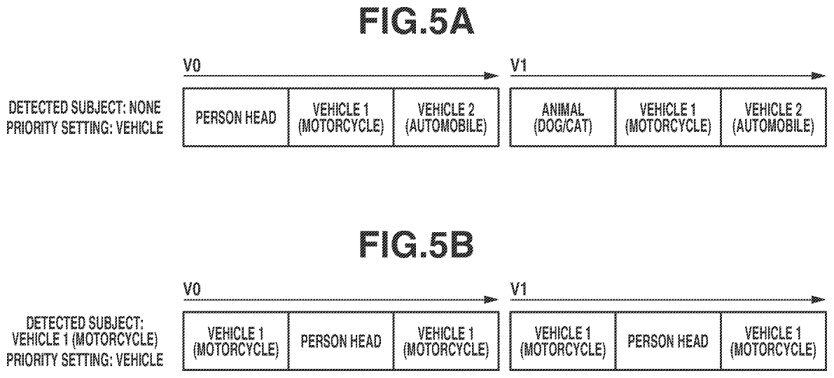

A sequence for switching between a plurality of types of dictionary data for one frame (one piece of image data) in step S403 will be described below with reference to FIGS. 5A and 5B. When a plurality of types of dictionary data is stored in the dictionary data storage unit 203, subject detection can be performed based on a plurality of dictionaries for one frame. On the other hand, in images and moving image data at the time of moving image recording in the live view mode in which images sequentially captured are output and processed, the number of times of subject detection that can be performed for one frame is assumed to be limited because of problems of the image capturing speed and processing speed.

In this case, the type and order of the dictionary data to be used may be determined according to, for example, the presence or absence of subjects detected in the past, the types of dictionary data used in the past detection, and the types of subjects to be preferentially detected. When a specific subject is included in a frame, the dictionary data for detecting the specific subject may not be selected depending on the dictionary data switching sequence, possibly missing the opportunity of subject detection.

Therefore, it is also necessary to change the dictionary data switching sequence according to settings and scenes.

FIGS. 5A and 5B illustrate examples of dictionary data switching sequences when a vehicle is selected as a subject to be preferentially detected in a structure where subject detection can be performed up to three times (or there are three different detectors that can perform processing in parallel) for one frame. Each of V0 and V1 indicates the vertical synchronization time period for one frame. Blocks enclosed in a square, such as Person Head, Vehicle 1 (Motorcycle), and Vehicle 2 (Automobile), indicate that subject detection based on three different types of dictionary data (learned models) can be performed in time series within one vertical synchronization time period.

FIG. 5A illustrates an example of dictionary data switching when no subject is detected. In the first frame, dictionary data switching is made in order of Person Head, Vehicle 1 (Motorcycle), and Vehicle 2 (Automobile). In the second frame, dictionary data switching is made in order of Animal (Dog/Cat), Vehicle 1 (Motorcycle), and Vehicle 2 (Automobile). For example, the imaging apparatus 100 constantly uses dictionary data enabling detecting a subject selected from the menu screen by the user, as illustrated in FIG. 3, without having a switching sequence. This case causes a trouble to change the priority detection subject setting for each scene, for example, selecting Vehicle when a vehicle is captured and selecting Person and Animal when other objects are captured. If the timing when a vehicle appears is unknown, selecting the priority detection subject setting after noticing a coming vehicle may possibly lose the timing of image capturing. On the other hand, the present exemplary embodiment enables the user to capture an image without considering the priority detection subject setting. More specifically, the present exemplary embodiment switches between all types of the dictionary data over a plurality of frames, as illustrated in FIG. 5A, during the time period when no specific subject is detected. By selecting the dictionary data according to the priority detection subject setting either in the first frame or the second frame while switching between all types of the dictionary data, the detection accuracy of the priority detection subject can be improved even while detecting all of the detectable subjects. This enables reducing the number of times of changing the priority detection subject setting. The imaging apparatus 100 may be separately provided with a mode in which only specific dictionaries (groups) are constantly accessed in order of precedence according to a setting specified by the user.

FIG. 5B illustrates an example of dictionary data switching in the next frame when a motorcycle is detected in the preceding frame. Dictionary data switching is made in order of Vehicle 1 (Motorcycle), Person Head, and Vehicle 1 (Motorcycle). The dictionary data switching does not necessarily need to be performed in the above-described order. For example, in the above-described example of dictionary data switching, the “Person Head” dictionary data may be changed according to a scene, for example, changed to the dictionary data with which subjects other than a motorcycle are likely to be selected in a motorcycle imaging scene. Also, in this case, exclusive control may be applied not to perform subject detection with the “Animal” dictionary data having low possibility of detection, in parallel with “Vehicle” dictionary data. A vehicle may be possibly mis-detected as an animal depending on the texture (design) and color of the vehicle. As a result, performing exclusive control in this way enables improving the detection accuracy for the desired subject.

In step S404, the subject detection unit 201 detects a subject (or the region where the subject exists) based on image data captured by the imaging unit 22 and input to the image processing unit 24, by using the dictionary data for detecting a specific subject (object) stored in the dictionary data storage unit 203. The position and size of the detected subject, information such as the calculated reliability, the type of the used dictionary data, and the identifier of the image data used for subject detection are stored in the detection history storage unit 202.

In step S405, the image processing unit 24 determines whether subject detection with all of the required dictionary data has been performed on image data having the same identifier (image data in the same frame), based on the subject detection history stored in the detection history storage unit 202. When subject detection with all of the required dictionary data has been performed (YES in step S405), the processing proceeds to step S406. On the other hand, when subject detection with all of the required dictionary data has not been performed (NO in step S405), the processing returns to step S403. In step S403, the image processing unit 24 selects the dictionary data to be used next.

In step S406, the image processing unit 24 determines whether subject detection with all types of the dictionary data has been performed, based on the subject detection history stored in the detection history storage unit 202. When subject detection with all types of the dictionary data has been performed (YES in step S406), the processing proceeds to step S407. On the other hand, when subject detection with all types of the dictionary data has not been performed (NO in step S406), the image processing unit 24 proceeds with the processing for the next frame. For example, referring to FIG. 5A, to perform subject detection with all of the required dictionary data, the image processing unit 24 requires two frames and therefore skips the processing of the subsequent stage in the first frame and then proceeds with the next frame. Therefore, the processing proceeds to step S407 in the second frame. According to the present exemplary embodiment, the image processing unit 24 skips the processing of the subsequent stage until subject detection with all of the required dictionary data has been performed. However, the present invention is not limited thereto. For processing that requires quick response such as automatic focusing, the image processing unit 24 may perform the subsequent stage processing only with a subject detected for each frame, without waiting for subject detection with all types of the dictionary data. For example, if all types of the currently set dictionary data can be accessed in order of precedence in two frames as in the present exemplary embodiment, the image processing unit 24 may constantly perform the subsequent stage processing in step S407 and subsequent steps based on the detection result for two frames including the last one of the past frames.

In step S407, the image processing unit 24 reads a setting for selecting a subject to be preferentially detected from among specific detectable subjects preset by the user via the operation unit 70.

In step S408, the image processing unit 24 determines whether a plurality of detection results exists in the same region based on the subject detection history for detection results of image data having the same identifier stored in the detection history storage unit 202.

When a plurality of detection results exists in the same region (YES in step S408), the processing proceeds to step S409. On the other hand, when a plurality of detection results does not exist (NO in step S408), the processing proceeds to step S410. The image processing unit 24 may determine that a plurality of detection results exists in the same region, for example, when detection center coordinates exist in another detection result region. The image processing unit 24 may also determine that a plurality of detection results exists in the same region when the detection regions overlap by a predetermined amount (e.g. a threshold ratio) or larger.

In step S409, the type determination unit 205 determines one region detection result based on the priority subject setting set in step S407, the detection results stored in step S405, and the result of the determination that a plurality of detection results exists in the same region in step S408. The determination method will be described below.

In step S410, the main subject determination unit 206 determines the main subject by using the priority subject setting set in step S407, from among the plurality of detection results of the image data having the same identifier based on the subject detection history stored in the detection history storage unit 202. In this case, when the image processing unit 24 determines that a plurality of detection results exists in the same region in step S408, the image processing unit 24 also uses the result in step S409. In this case, the system control unit 50 may display a part or all of the information output by the main subject determination unit 206, on the display unit 28. The determination method will be described below.

### (Flow of Type Determination Processing for Determining Type of Subject Based on a Plurality of Subject Detection Results in the Same Region)

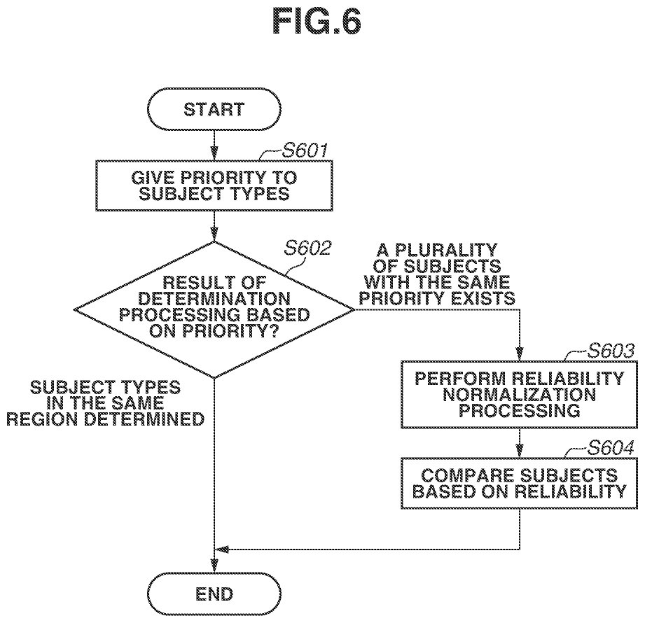

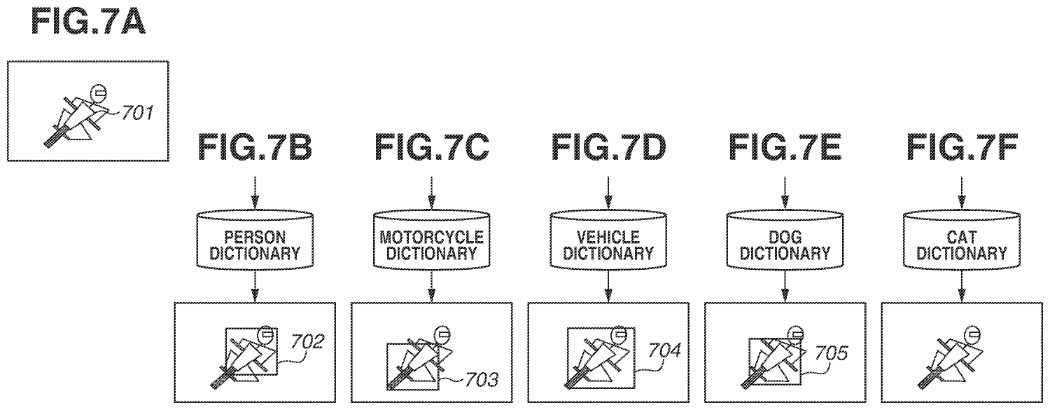

The type determination processing in step S409 will be described below with reference to the flowchart in FIG. 6, the type determination processing in FIGS. 7A to 7F, and Table 1. Each step of this flowchart is executed by the system control unit 50 or by each unit following an instruction of the system control unit 50.

FIGS. 7A to 7F illustrate examples of the type determination processing. FIG. 7A illustrates an input image in which a motorcycle 701 is captured as a subject. FIG. 7B illustrates a state where the person dictionary is selected in step S403, and a person 702 is detected. FIG. 7C illustrates a state where the motorcycle dictionary is selected in step S403, and a motorcycle 703 is detected. FIG. 7D illustrates a state where the automobile dictionary is selected in step S403, and an automobile 704 is mis-detected. FIG. 7E illustrates a state where the dog dictionary is selected in step S403, and a dog 705 is mis-detected. FIG. 7F illustrates a state where the cat dictionary is selected in step S403, and, as a result of the processing, no detection result is obtained.

In step S601, the image processing unit 24 gives priority to each of the subject types to be detected according to the priority setting set in step S407.

Table 1 illustrates an example of priority classification by priority settings and subject types. Referring to Table 1, the vertically arranged priority settings include “Person”, “Animal”, “Vehicle”, “None”, and “Automatic” according to the setting method in FIG. 3. The horizontally arranged subject types to be detected include “Person”, “Cat”, “Dog”, “Automobile”, and “Motorcycle” according to the type determination processing in FIGS. 7A to 7F. Referring to Table 1, a smaller priority number indicates a higher priority, and “No Priority” indicates that the subject is not used.

Although, in the present exemplary embodiment, subjects are classified into three different subjects (values): priority subject (Priority 1 in Table 1), non-priority subject (Priority 2 in Table 1), and unadopted subject (No Priority in Table 1), the present invention is not limited thereto. For example, subjects may be classified into two different subjects (values): used subject and unadopted subject. Subjects may be classified into four different subjects (values): top priority subject, priority subject, non-priority subject, and unadopted subject. The number of subject types can be changed according to the number of detectable subject types and the possible priority settings. Referring to Table 1, when Vehicle is selected as a priority subject, Automobile and Motorcycle are classified as priority subjects, Person is classified as a non-priority subject, and Dog and Cat are classified as unadopted subjects. However, the classification method is not limited thereto. For example, subject types other than subject types with the priority setting (also referred to as priority subject types) are not to be detected, Person may also be classified as an unadopted subject. If subject types other than the priority subject types are to be detected, Dog and Cat may be classified as non-priority subjects.

TABLE 1

| | | Subject to be detected | | | | |
|---|---|---|---|---|---|---|
| | | | | | | Motor- |
| | | Person | Dog | Cat | Automobile | cycle |
| Priority | Person | Priority | Priority | Priority | Priority | Priority |
| setting | | 1 | 2 | 2 | 2 | 2 |
| | Animal | Priority | Priority | Priority | No | No |
| | | 2 | 1 | 1 | priority | priority |
| | Vehicle | Priority | No | No | Priority | Priority |
| | | 2 | priority | priority | 1 | 1 |
| | None | No | No | No | No | No |
| | | priority | priority | priority | priority | priority |
| | Automatic | Priority | Priority | Priority | Priority | Priority |
| | | 1 | 1 | 1 | 1 | 1 |

In step S602, the image processing unit 24 performs the priority-based subject type determination processing for the same region according to the priority determined in step S601.

A specific method will be described below with reference to the type determination processing in FIGS. 7A to 7F. Referring to Table 1, when Person is assigned a priority setting, a Person subject type is given Priority 1 and hence the image processing unit 24 confirms whether a detection result for Person exists. Since a person 702 in FIG. 7B exists, the image processing unit 24 adopts the person 702 as a subject type in the region, and then terminates the type determination processing. When Vehicle is assigned a priority setting, Automobile and Motorcycle subject types are given Priority 1, as illustrated in Table 1. Therefore, the image processing unit 24 confirms whether detection results for Automobile and Motorcycle with Priority 1 exist. Since both a motorcycle 703 (FIG. 7C) and an automobile 704 (FIG. 7D) exist, the processing proceeds to step S603. In this case, when neither the motorcycle 703 (FIG. 7C) nor the automobile 704 (FIG. 7D) exists, the image processing unit 24 confirms whether a detection result of Person with Priority 2 exists. When no detection result for Person exists, the image processing unit 24 determines that no subject exists in the same region since Dog and Cat are given “No Priority”, as illustrated in Table 1, and then terminates the type determination processing.

In step S603, the image processing unit 24 subjects the reliabilities of the detection results stored in step S405 to normalization processing for each subject. The normalization is performed because the maximum value of the reliability of a detection result and the threshold value of the reliability as a subject are different for each individual adopted dictionary. The normalization enables the reliability comparison between subjects with different dictionaries in the subsequent stage processing. According to the present exemplary embodiment, the minimum and maximum values of the reliability that can be taken for each dictionary are normalized to 0 and 1, respectively. This normalization limits the reliability to a value between 0 to 1, enabling the subject comparison based on the reliability. The normalization method is not limited thereto. For example, the threshold value of the reliability as a subject may be set to 1, and the minimum value of the reliability that can be taken may be set to 0.

When the image processing unit 24 confirms that a plurality of subject types with the same priority exists in step S602, then in step S604, the image processing unit 24 determines a subject with a high reliability as a result of the normalization in step S603 as a subject in the region, and then terminates the type determination processing. Although the present exemplary embodiment determines a subject in the region based on the reliability, the determination method is not limited thereto. For example, the image processing unit 24 may refer to the detection results of the past frames to determine the subject type detected the largest number of times in a plurality of frames, as a subject in the region.

Referring to FIGS. 7A to 7F, the image processing unit 24 determines the motorcycle 703 in FIG. 7C and the automobile 704 in FIG. 7D as priority subjects in the same region in step S602, and then compares the two subjects. According to the present exemplary embodiment, since the input subject is the motorcycle 701, the image processing unit 24 determines the motorcycle 703 as a subject in the region on the assumption that the motorcycle 703 in FIG. 7C has the highest reliability.

Prior to the reliability comparison in step S604, the image processing unit 24 selects subjects based on the priority in step S602. Assume a case of a dog and a cat as subjects having similar common features, such as four-legged locomotion. In this case, if a cat image is input to the dog dictionary, the cat is highly likely to be mis-detected as a dog. However, assume a case of a dog and a motorcycle as subjects having unlike common features. In this case, if a motorcycle image is input to the dog dictionary, the motorcycle is unlikely to be mis-detects as a dog. However, in a case of mis-detection of the dog 705 in FIG. 7E, it is difficult to determine which feature of the input image has been perceived, possibly resulting in a high reliability. In such a case, it may be difficult to prevent the final output from being mis-detected as a dog. Therefore, the image processing unit 24 firstly performs subject selection according to the set priority to eliminate mis-detection for undesired subjects.

### (Flow of Main Subject Determination Processing)

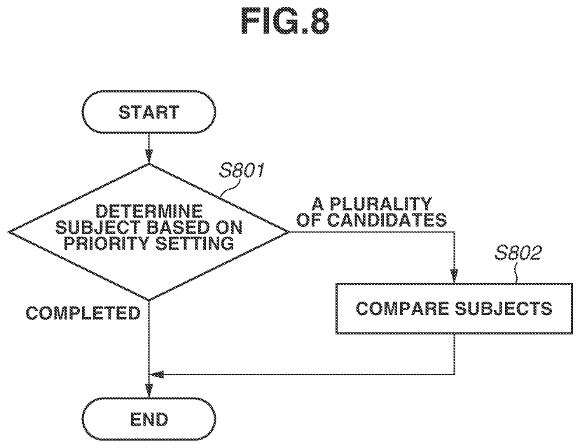

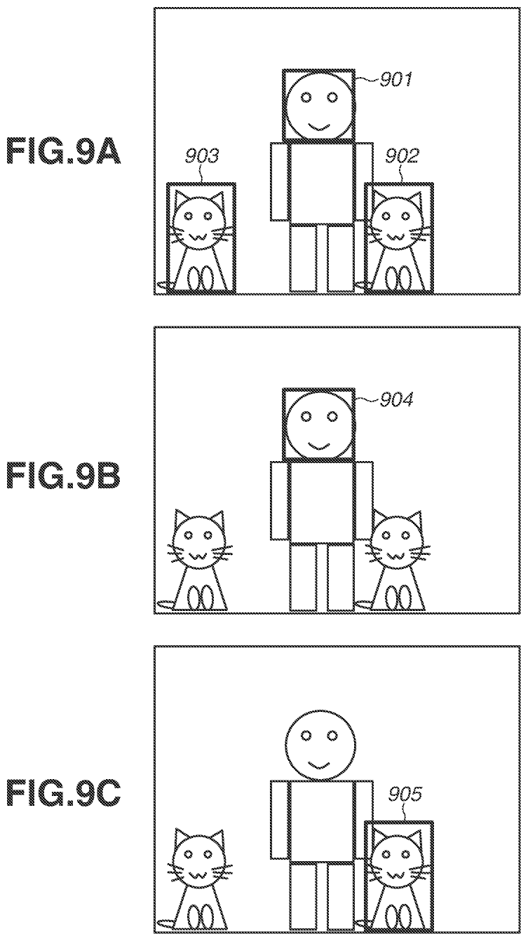

The main subject determination processing in step S410 will be described below with reference to the flowchart in FIG. 8 and the images in FIGS. 9A to 9C. Each step of this flowchart is executed by the system control unit 50 or by each unit according to an instruction of the system control unit 50.

FIGS. 9A to 9C illustrate an example of the main subject determination when a plurality of subjects is detected in the same frame. FIG. 9A illustrates a state where a person face 901 and cats 902 and 903 are detected.

FIG. 9B illustrates a state where a person face 904 is selected as the main subject from among the person face 901 and the cats 902 and 903. FIG. 9C illustrates a state where a cat 905 is selected as the main subject from among the person face 901 and the cats 902 and 903.

In step S801, the image processing unit 24 selects main subject candidates according to the priority setting set in step S407. In this case, when the main subject candidate is uniquely determined, the image processing unit 24 selects the main subject candidate as the main subject, and then terminates the main subject determination processing. When no candidate exists, the image processing unit 24 determines that no main subject exists, and then terminates the main subject determination processing. When a plurality of subject candidates exists (A PLURALITY OF CANDIDATES in step S801), the processing proceeds to step S802.

A specific example of the main subject determination will be described below with reference to FIGS. 9A to 9C.

When “Person” in FIG. 3 is set in step S407, the image processing unit 24 selects the person face 904 in FIG. 9B as the main subject from among the person face 901 and the cats 902 and 903 in FIG. 9A according to the priority setting, and then terminates the main subject determination.

When “Animal” in FIG. 3 is set in step S407, a plurality of detection results for Cat exists out of the person face 901 and the cats 902 and 903 in FIG. 9A. Then, the processing proceeds to step S802.

When “Automatic” in FIG. 3 is set in step S407, there is no subject to be preferentially detected and therefore a plurality of detection results for Person and Cat exists. Then, the processing proceeds to step S802.

When “Vehicle” in FIG. 3 is set in step S407, none of the person face 901 and the cats 902 and 903 in FIG. 9A is selected as a subject. Therefore, the image processing unit 24 determines that no main subject exists, and then terminates the main subject determination processing.

In step S802, the image processing unit 24 selects the main subject from among the plurality of subject candidates determined in step S801, based on the positions, sizes, and reliabilities of the subjects detected in step S404. For example, assume a case where the image processing unit 24 selects a subject close to the center of the angle of field as the main subject. In this case, when the person face 901 and the cats 902 and 903 remain as subject candidates in step S801, the image processing unit 24 selects the person face 904 in FIG. 9B as the main subject because the person face 901 is closest to the center.

When the cats 902 and 903 remain as subject candidates, the image processing unit 24 selects the cat 905 in FIG. 9C as the main subject because the cat 902 is the closest to the center.

Although, in the present exemplary embodiment, the image processing unit 24 selects a subject close to the center of the angle of field out of candidate subjects as the main subject, the present invention is not limited thereto. For example, the image processing unit 24 may select the subject closest to the center of the region subjected to automatic focusing as the main subject, select the subject having the largest size as the main subject, select the subject having the highest detection subject reliability as the main subject, and determine the main subject by compositely determining these factors.

(Exemplary Embodiment when User Performs Specification Operation in Screen)

The above-described exemplary embodiment is based on an example where the imaging apparatus 100 automatically detects subjects, determines subject types in the same region, and determines the main subject. The present exemplary embodiment will be described below centering on an example where, when the user specifies a certain region in the live view screen displayed on the display unit 28, the image processing unit 24 changes the dictionary switching sequence, determines the subject types in the same region, and determines the main subject.

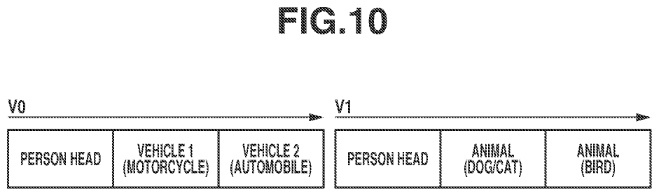

The dictionary switching sequence performed by the dictionary data selection unit 204 in step S403 when the user specifies an arbitrary region in the live view screen will be described below with reference to FIG. 10.

Referring to FIGS. 5A and 5B, the image processing unit 24 changes the dictionary switching sequence according to the previously detected subjects and the priority detection subject setting. However, according to the present exemplary embodiment, when the user specifies a region in the live view screen, the image processing unit 24 changes all of the detectable dictionaries regardless of the previously detected subjects and the priority detection subject setting. This processing is intended to exactly detect subjects in the specified region by switching between all of the detectable dictionaries to exactly reflect the region specification by the user regardless of the previously detected subjects.

An example of dictionary data switching will be described below with reference to FIG. 10. The image processing unit 24 switches between the dictionary data in order of Person Head, Vehicle 1 (Motorcycle), and Vehicle 2 (Automobile) in the first frame, switches between the dictionary data in order of Person Head, Animal (Dog/Cat), and Animal (Bird) in the second frame, and switches between the dictionary data over a plurality of frames. Although, in the present exemplary embodiment, the image processing unit 24 switches the Person Head dictionary in both the first and second frames, the image processing unit 24 may change the Person Head dictionary in either frame to another dictionary according to the priority detection subject setting. For example, when Vehicle is given priority, the image processing unit 24 may use any one of the vehicle dictionaries in the second frame. When Animal is given priority, the image processing unit 24 may use any one of the animal dictionaries in the second frame.

The type determination processing in step S409 will be described below centering on characteristic processing according to the present exemplary embodiment.

The present exemplary embodiment performs the type determination processing when a plurality of types of subjects is detected in a region specified by the user.

The main subject determination processing in step S410 will be described below centering on characteristic processing according to present exemplary embodiment. The present exemplary embodiment determines a subject existing in the region specified by the user, as the main subject.

When no subject is detected in the specified region, the image processing unit 24 determines the specified region as the main subject. However, in the dictionary data switching sequence in step S403 in the next frame, the image processing unit 24 subsequently switches between all of the dictionaries until a detectable subject is detected in the specified region.

The image processing unit 24 may limit the subject types in the specified region to be determined as the main subject according to the priority detection subject setting. Examples of possible limitations are as follows. When Person is given priority, all subjects can be selected as the main subject. When Animal is given priority, a vehicle detected in the specified region is not selected as the main subject. When Vehicle is given priority, an animal detected in the specified region is not selected as the main subject. When limiting the type of the main subject, the image processing unit 24 may select the specified region as the main subject like above-described case where no subject is detected in the specified region, or adopt only the positions and sizes of subjects out of detection results.

When a limited subject is determined to be specified, the image processing unit 24 may use the dictionaries with the priority setting without selecting the dictionary of the limited subject in the next and subsequent frames. Assume an example case where Animal is given priority. In this case, when a vehicle subject is specified, the image processing unit 24 selects no vehicle dictionary not to detect a vehicle but frequently switches between animal dictionaries in the subsequent frames, making it easier to detect an animal. Performing control in this way makes it easier to transfer to a subject with the priority setting.

The present exemplary embodiment has been described above centering on the region specification in the display screen of the display unit 28 in the live view image capturing, where the display unit 28 successively displays images sequentially input from the image sensor. However, the user may specify a region on the screen displayed in the finder by using the line of sight, or specify a region on the screen displayed in the live view screen or the finder by operating a displayed pointer. The method for specifying a region is not limited.

While the present invention has specifically been described based on the above-described exemplary embodiments, the present invention is not limited thereto but can be modified and changed in diverse ways within the ambit of the appended claims.

The present invention makes it possible to select a correct detection type even in a case where a plurality of detection results by a plurality of dictionaries exists for the same subject.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation.

This application claims the benefit of Japanese Patent Application No. 2021-065015, filed Apr. 6, 2021.

What is claimed is:

1. An image processing apparatus comprising:
one or more processors;
a memory storing instructions which, when the instructions are executed by the one or more processors, cause the image processing apparatus to function as:
a detection unit configured to detect a plurality of types of subjects for an input image;
a setting unit configured to set a type of a subject as a priority subject; and
a main subject determination unit configured to determine a detection result as a main subject based on the plurality of types of subjects detected by the detection unit,
wherein, in a case where detection results of a plurality of types of subjects exist in a same region, the main subject determination unit determines one subject type in the same region based on the set priority subject and the types of the detected subjects.

2. The image processing apparatus according to claim 1, further comprising a calculation unit configured to calculate detection reliability for the subjects detected by the detection unit, wherein the main subject determination unit determines a subject type in the same region based on the reliability calculated by the calculation unit.

3. The image processing apparatus according to claim 1,
wherein the detection unit has dictionary data that has completed learning based on a neural network for each subject type, and
wherein the dictionary data includes different network parameters.

4. The image processing apparatus according to claim 1, further comprising a control unit configured to switch between a plurality of types of dictionary data based on a predetermined setting.

5. The image processing apparatus according to claim 1, wherein, after acquiring detection results of a plurality of preset types of subjects, the main subject determination unit performs processing for determining the main subject.

6. The image processing apparatus according to claim 1, wherein a priority is set for each subject type.

7. The image processing apparatus according to claim 1, wherein, in a case where detection results of the plurality of types of subjects exist in the same region, the main subject determination unit determines the subject having a highest priority as the main subject.

8. The image processing apparatus according to claim 1, wherein, in a case where detection results of a plurality of types of subjects having a same priority exist in the same region, the main subject determination unit determines the subject having a highest reliability as the main subject.

9. The image processing apparatus according to claim 1, wherein the main subject determination unit normalizes reliability according to the subject types and determines the main subject by using the normalized reliability.

10. The image processing apparatus according to claim 4, wherein, in a case where an arbitrary region of the input image is specified, the control unit selects a switching sequence that switches between all of detectable dictionaries.

11. A method for controlling an image processing apparatus, the method comprising:
detecting a plurality of types of subjects for an input image;
setting a type of a subject as a priority subject; and
determining, in main subject determination, a detection result as a main subject based on the plurality of types of subjects detected by the detection,
wherein, in a case where detection results of a plurality of types of subjects exist in a same region, the main subject determination determines one subject type in the same region based on the set priority subject and the types of the detected subjects.

12. A method according to claim 11, further comprising calculating detection reliability for the subjects detected by the detection unit, wherein the main subject determination determines a subject type in the same region based on the reliability.

13. A non-transitory computer-readable storage medium storing a program for causing a computer to execute each process of the method for controlling an image processing apparatus according to claim 11.
